(19) United States
(12) Patent Application Publication
(10) Pub. No.: US 2005/0270592 A1
(43) Pub. Date: Dec. 8, 2005

(54) Carrier structure

(76) Inventors: Brian Lian, Taiei (TW); Ben JH Hsu, Changhua (TW)

Correspondence Address: HARNESS, DICKEY & PIERCE, P.L.C., P.O. BOX 8910, RESTON, VA, 20195, US

(21) Appl. No.: 10/860,279

(22) Filed: Jun. 4, 2004

(51) Int. Cl. H04N 1/04

(52) U.S. Cl. 358/474

(57) ABSTRACT

A carrier structure is used in a scanner apparatus for carrying optical module back and forth in the scanner apparatus. The carrier structure comprises a housing, a rod, and at least one bearing having a fixed section. The rod inserts into the bearing and sets on the housing by the fixed section of the bearing. Thus, the housing moves along linear path.

### FIELD OF THE INVENTION

The present invention relates to a carrier structure adopted for use on scanner apparatus and particularly to a carrier structure capable of saving time and efforts required in measuring and correcting bearing coaxial alignment and perpendicularity.

### BACKGROUND OF THE INVENTION

A scanner apparatus usually has an optical module to capture the image of a document placed on a glass board. In order to move the optical module, the scanner apparatus usually has rods at two ends of the optical module to guide the movement of the optical module to perform scanning operation.

Refer to FIG. 1 for a conventional carrier structure. The rods run through two sleeves at two ends of an optical module. As the sleeves do not have bearings located therein, movement of the optical module on the rods is not smooth.

FIG. 2 illustrates another conventional carrier structure. The optical module has plastic sleeves at two ends to couple with bearings, and a rod runs through the two bearings held in the plastic sleeves to couple with the optical module. In practice, after the bearings have been coupled with the plastic sleeves, the axial alignment and perpendicularity of the two bearings will affect the movement of the optical module on the rod. Hence after the bearings have been coupled on the plastic sleeves, the axial alignment and perpendicularity at two ends of the bearings have to be measured. The measurement ensures that they are within the allowable range. So the optical module is moved smoothly as desired on the rod coupled with the plastic sleeves. However, adopting such a technique still cannot ensure that the coaxial alignment of the plastic sleeves can be maintained after injection within the allowable range. And the coaxial alignment and perpendicularity of the bearings after coupled with the plastic sleeves also are not necessary within the allowable range. Hence the coaxial alignment and perpendicularity of the bearings must be calibrated before coupling with the rod, to ensure smooth coupling. If the coaxial alignment and perpendicularity do not conform to the required standards, the bearings have to be modified and corrected. This takes considerable time.

Refer to FIGS. 3A and 3B for yet another conventional carrier structure. It has two fixed elements located on two ends of the optical module and movable sleeves movably coupled on the fixed elements. After the movable sleeves have been mounted on the fixed elements, the bearings may be disposed in the movable sleeves as previously discussed. And the rod may be coupled with the bearings. Such a technique also has the problems mentioned above. FIG. 4 shows still another conventional carrier structure. It also has the same problems mentioned above.

### SUMMARY OF THE INVENTION The primary object of the invention is to provide a carrier structure to save time and efforts in measuring and correcting coaxial alignment and perpendicularity of the bearings coupled on the rods at two ends of the optical module, and enable the housing to be movable on a linear path.

The carrier structure of the invention is adopted for use on scanner apparatus to carry an optical module back and forth in the scanner apparatus. It includes a pair of bearings, a rod and a housing. The bearing has a fixed section. The rod runs through the bearings. The housing has a coupling surface to allow the fixed section of the bearing to be directly mounted thereon so that the housing may be moved on a linear path.

For installation, first, have the rod running through the bearings; then place the fixed section of the bearing in contact with the coupling surface of the housing. Finally, fastening elements are used to fasten screw holes to restrict the movement of the bearings. The carrier structure thus formed can save time and efforts in measuring and correcting coaxial alignment and perpendicularity of the bearings, coupled on the rods at two ends of the optical module.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional carrier structure.

FIG. 2 is a perspective view of another conventional carrier structure.

FIGS. 3A and 3B are perspective views of yet another conventional carrier structure.

FIG. 4 is a perspective view of still another conventional carrier structure.

FIG. 5 is a fragmentary perspective view of the first embodiment of the invention.

FIG. 6 is a perspective view of the first embodiment of the invention.

FIG. 7 is a fragmentary perspective view of the second embodiment of the invention.

FIG. 8 is a perspective view of the second embodiment of the invention.

FIG. 9 is a fragmentary perspective view of the third embodiment of the invention.

FIG. 10 is a perspective view of the third embodiment of the invention.

FIG. 11 is a fragmentary perspective view of the fourth embodiment of the invention.

FIG. 12 is a perspective view of the fourth embodiment of the invention.

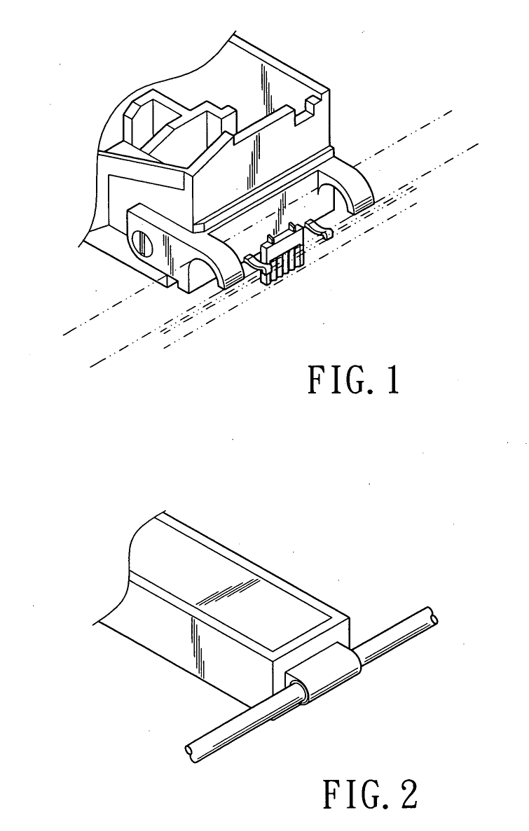

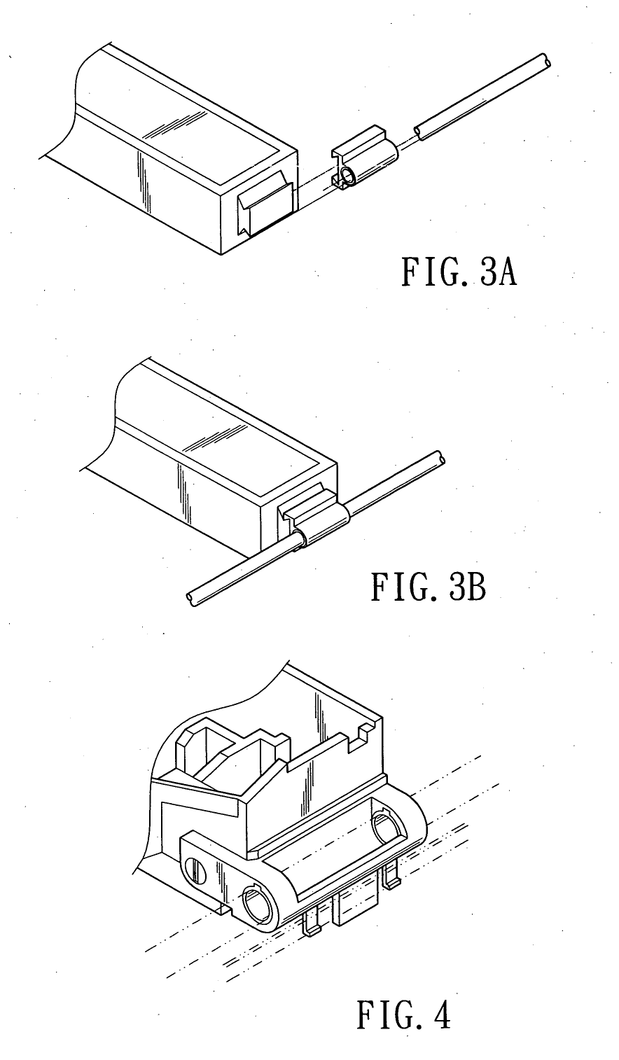

### DESCRIPTION OF THE PREFERRED EMBODIMENTS

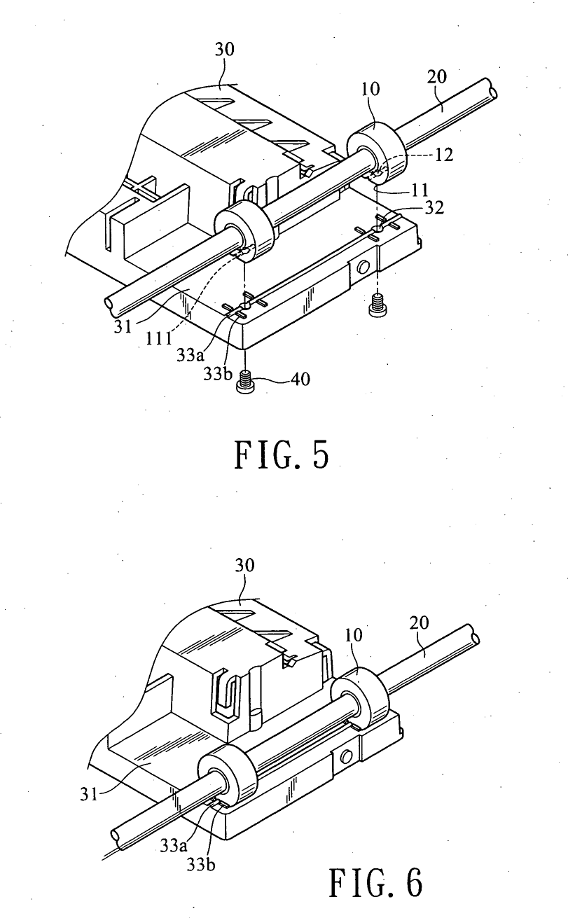

Refer to FIGS. 5 and 6 for a first embodiment of the carrier structure of the invention. It is adopted for used on scanner apparatus to carry an optical module to move back and forth in the scanner apparatus. The carrier structure according to the invention includes a pair of bearings 10, a rod 20 and a housing 30.

The bearings 10 have respectively a fixed section 11, a cutoff, for directly installing the bearings 10 on the housing 30. The fixed section 11 has a trough 111 in the second dimension. The bearing 10 further has a screw hole 12 located on the fixed section 11 in the first dimension.

The rod 20 runs through the bearings 10. The housing 30 has a coupling surface 31 to allow the fixed section 11 of the bearings 10 to be directly mounted thereon so that the housing 30 is moved along a linear path. To directly mount the bearing 10 onto the housing 30, the housing 30 has a fastening screw hole 32 corresponding to the screw hole 12. So by the screw hole 12 and the fastening screw hole 32, the bearing 10 and the housing 30 are coupled by a fastening element 40 (a screw is shown in the drawings) for directly fastening the fixed section 11 to the housing 30. For the housing 30 without the fastening screw hole 32 and the bearing 10 without the screw hole 12, a self-tapping screw fastening element 40 (not shown in the drawings) may be used.

The housing 30 further has bearing retaining members 33a and 33b located on the coupling surface 31, corresponding to the bearing 10, to restrict the movement of the fixed section 11 on the coupling surface 31. The first bearing retaining member 33a is formed on the housing 30 in a protrusive manner corresponding to the trough 111 in the second dimension. The second bearing retaining member 33b is formed on the housing 30 in a protrusive manner corresponding to two opposing sides of the fixed section 11 in the third dimension.

For installation, the rod 20 runs through the bearings 10 first. Then place the fixed section 11 of the bearing 10 in contact with the coupling section 31 of the housing 30. The first bearing retaining member 33a restricts the movement of the bearing 10 in the second dimension, and the second bearing retaining member 33b restricts the movement of the bearing 10 in the third dimension. Finally, the screw hole 12 and the fastening screw hole 32 are fastened by the fastening element 40 to restrict the movement of the bearing 10 in the first dimension.

The rod 20 runs through the bearings 10, and the fixed section 11 of the bearings 10 directly mounted onto the housing 30 saves time and efforts required for measuring and correcting coaxial alignment and perpendicularity of the bearings 10.

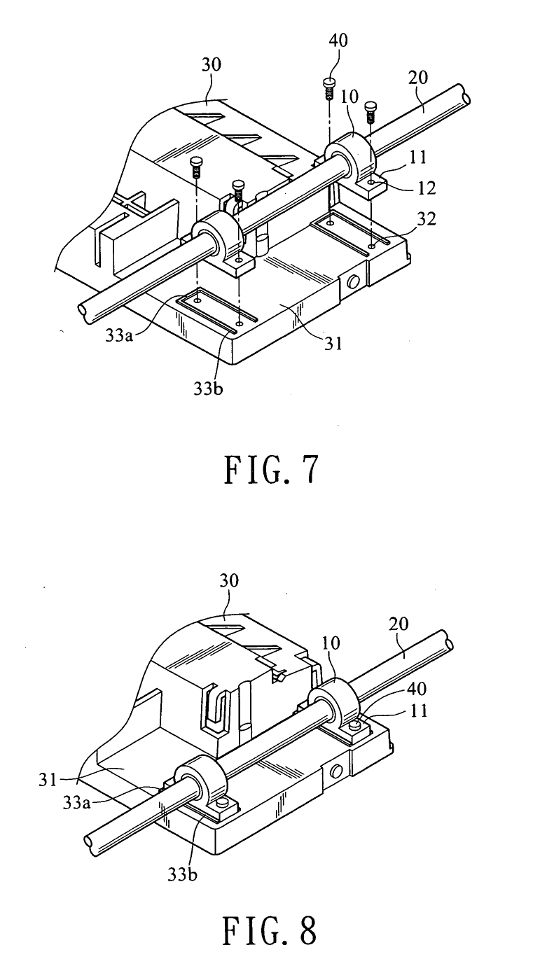

Refer FIGS. 7 and 8 for a second embodiment of the carrier structure of the invention. It is adopted for use on scanner apparatus to carry an optical module, to move back and forth in the scanner apparatus. The carrier structure according to the invention includes a pair of bearings 10, a rod 20 and a housing 30.

The bearings 10 have respectively a fixed section 11 for installing the bearings 10 on the housing 30. The fixed section 11 has a trough 111 on the second dimension. The bearing 10 further has a screw hole 12 located on the fixed section 11 in the first dimension.

The rod 20 runs through the bearings 10. The housing 30 has a coupling surface 31 to allow the fixed section 11 of the bearings 10 to be directly mounted thereon so that the housing 30 may be moved along a linear path. To directly mount the bearing 10 onto the housing 30, the housing 30 has a fastening screw hole 32 corresponding to the screw hole 12. So by the screw hole 12 and the fastening screw hole 32, the bearing 10 and the housing 30 are coupled by a fastening element 40 (a screw is shown in the drawings) for directly fastening the fixed section 11 to the housing 30. For the housing 30 without the fastening screw hole 32 and the bearing 10 without the screw hole 12, a self-tapping screw fastening element 40 (not shown in the drawings) is used.

The housing 30 further has bearing retaining members 33a and 33b located on the coupling surface 31 corresponding to the bearing 10, to restrict the movement of the fixed section 11 on the coupling surface 31. The first bearing retaining member 33a is formed on the housing 30 in a protrusive manner corresponding to the fixed section 11 in the second dimension. The second bearing retaining member 33b is formed on the housing 30 in a protrusive manner corresponding to the fixed section 11 in the third dimension.

For installation, the rod 20 runs through the bearings 10 first. Then place the fixed section 11 of the bearings 10 in contact with the coupling section 31 of the housing 30. The first bearing retaining member 33a restricts the movement of the bearing 10 in the second dimension, and the second bearing retaining member 33b restricts the movement of the bearing 10 in the third dimension. Finally, the screw hole 12 and the fastening screw hole 32 are fastened by a fastening element 40 to restrict the movement of the bearing 10 in the first dimension.

The rod 20 runs through the bearings 10, and the fixed section 11 of the bearings 10 directly mounted onto the housing 30 saves time and efforts required for measuring and correcting coaxial alignment and perpendicularity of the bearings 10.

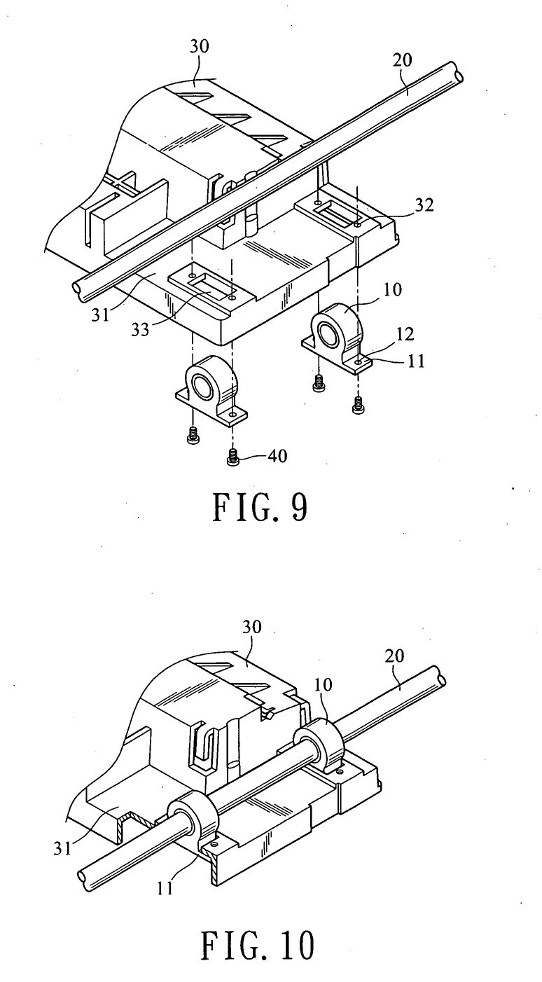

Refer FIGS. 9 and 10 for a third embodiment of the carrier structure of the invention. It is adopted for used on scanner apparatus to carry an optical module to move back and forth in the scanner apparatus. The carrier structure according to the invention includes a pair of bearings 10, a rod 20 and a housing 30.

The bearings 10 have respectively a fixed section 11, formed in screw flanges for installing the bearings 10 on the housing 30. The fixed section 11 has a trough 111 on the second dimension. The bearing 10 further has screw holes 12 located on the fixed section 11 in the first dimension.

The rod 20 runs through the bearings 10. The housing 30 has a coupling surface 31 to allow the fixed section 11 of the bearings 10 to be directly mounted thereon so that the housing 30 is moved along a linear path. To directly mount the bearing 10 onto the housing 30, the housing 30 has fastening screw holes 32 corresponding to the screw holes 12. So by the screw hole 12 and the fastening screw hole 32, the bearing 10 and the housing 30 are coupled by fastening elements 40 (screws are shown in the drawings) for directly fastening the fixed section 11 to the housing 30. For the housing 30 without the fastening screw holes 32 and the bearing 10 without the screw holes 12, self-tapping screw fastening elements 40 (not shown in the drawings) are used.

The housing 30 further has a bearing retaining member 33 located on the coupling surface 31 that is a bore corresponding to the fixed section 10 to restrict the movement of the fixed section 11 on the coupling surface 31.

For installation, the rod 20 runs through the bearings 10 first. Then place the fixed section 11 of the bearings 10 in contact with the coupling section 31 of the housing 30. The bearing retaining member 33 restricts the movement of the bearing 10 in the second and third dimensions. Finally, the screw holes 12 and the fastening screw holes 32 are fastened by the fastening element 40, to restrict the movement of the bearing 10 in the first dimension.

The rod 20 runs through the bearings 10, and the fixed section 11 of the bearings 10 directly mounted onto the housing 30 saves time and efforts required for measuring and correcting coaxial alignment and perpendicularity of the bearings 10.

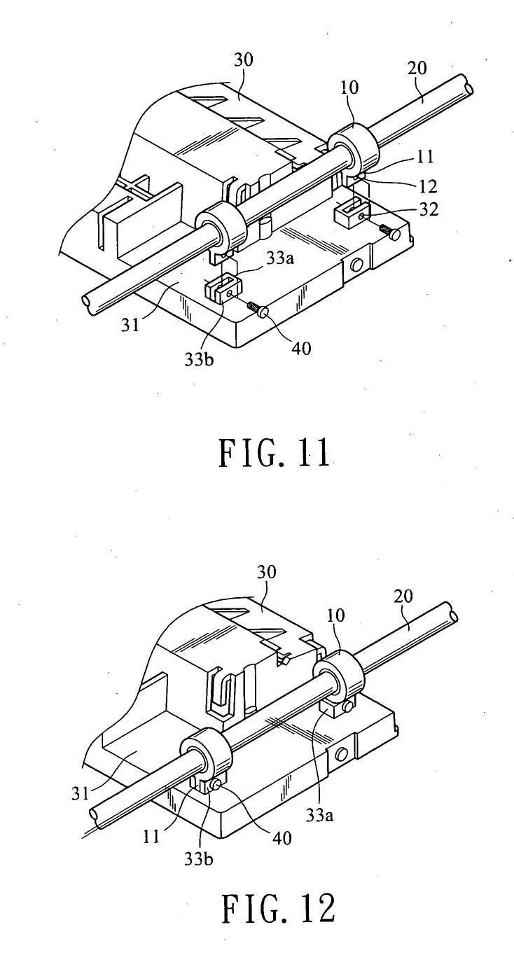

Refer to FIGS. 11 and 12 for a fourth embodiment of the carrier structure of the invention. It is adopted for used on scanner apparatus to carry an optical module to move back and forth in the scanner apparatus. The carrier structure according to the invention includes a pair of bearings 10, a rod 20 and a housing 30. The bearings 10 have respectively a fixed section 11 formed in a screw flange for directly installing the bearings 10 on the housing 30. The fixed section 11 has a trough 111 on the second dimension. The bearing 10 further has a screw hole 12 located on the fixed section 11 in the first dimension.

The rod 20 runs through the bearings 10. The housing 30 has a coupling surface 31 to allow the fixed section 11 of the bearings 10 to be directly mounted thereon so that the housing 30 may be moved along a linear path. To directly mount the bearing 10 onto the housing 30, the housing 30 has fastening screw holes 32, corresponding to the screw hole 12. So by the screw hole 12 and the fastening screw hole 32, the bearing 10 and the housing 30 are coupled by a fastening element 40 (a screw is shown in the drawings) for directly fastening the fixed section 11 to the housing 30. For the housing 30 without the fastening screw holes 32 and the bearing 10 without the screw hole 12, a self-tapping screw fastening element 40 (not shown in the drawings) is used.

The housing 30 further has bearing retaining members 33a and 33b located on the coupling surface 31 corresponding to the bearing 10 to restrict the movement of the fixed section 11 on the coupling surface 31. The first bearing retaining member 33a is located on the housing 30 in a protrusive manner corresponding to the fixed section 11 in the first dimension. The second bearing retaining member 33b is formed on the housing 30 in a protrusive manner corresponding to two opposite sides of the fixed section 11 in the second dimension.

For installation, the rod 20 runs through the bearings 10 first. Then place the fixed section 11 of bearings 10 in contact with the coupling section 31 of the housing 30. The first bearing retaining member 33a restricts the movement of the bearing 10 in the first dimension, and the second bearing retaining member 33b restricts the movement of the bearing 10 in the second dimension. Finally, the screw hole 12 and the fastening screw holes 32 are fastened by the fastening element 40, to restrict the movement of the bearing 10 in the first dimension.

The rod 20 runs through the bearings 10, and the fixed section 11 of the bearings 10 directly mounted onto the housing 30 saves time and efforts required for measuring and correcting coaxial alignment and perpendicularity of the bearings 10.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A carrier structure adopted for use on a scanner apparatus to carry an optical module to move back and forth in the scanner apparatus, comprising:
a pair of bearings having respectively a fixed section;
a rod running through the bearings; and
a housing having a coupling surface to allow the fixed section to be directly installed thereon such that the housing is movable linearly.

2. The carrier structure of claim 1, further having a fastening element for fastening the housing to the bearing to directly install the fixed section of the bearings on the housing.

3. The carrier structure of claim 2, wherein the fastening element is a self-tapping screw.

4. The carrier structure of claim 2, wherein the bearing has a screw hole formed on the first dimension of the fixed section, the housing having a fastening screw hole corresponding to the screw hole for fastening the housing to the bearings to directly install the fixed section of the bearings on the housing.

5. The carrier structure of claim 4, wherein the fastening element is a screw.

6. The carrier structure of claim 4, wherein the fixed section is a cutoff surface which has a trough formed on the second dimension.

7. The carrier structure of claim 6, wherein the housing has a plurality of bearing retaining members located on the coupling surface corresponding to the bearings to restrict the fixed section from moving on the coupling surface.

8. The carrier structure of claim 7, wherein the bearing retaining members are formed in a protrusive manner on the housing corresponding to the trough.

9. The carrier structure of claim 7, wherein the bearing retaining members are formed in a protrusive manner on the housing corresponding to two opposite sides of the third dimension of the fixed section.

10. The carrier structure of claim 1, wherein the fixed section is a screw flange which has a screw hole on the first dimension.

11. The carrier structure of claim 10, wherein the housing has a plurality of bearing retaining members located on the coupling surface corresponding to the bearings to restrict the fixed section from moving on the coupling surface.

12. The carrier structure of claim 11, wherein the bearing retaining members are formed in a protrusive manner on the housing corresponding to the second dimension and two opposing sides of the third dimension of the fixed section.

13. The carrier structure of claim 11, wherein the bearing retaining members are bores corresponding to the fixed section to restrict the fixed section from moving in the second and the third dimensions.

14. The carrier structure of claim 11, wherein the bearing retaining members are formed in a protrusive manner on the housing corresponding to the first dimension and two opposite sides of the second dimension of the fixed section.

15. A bearing adopted for use on a rod of an optical module of a scanner apparatus comprising a fixed section to be directly installed on a housing of the optical module such that the housing is movable linearly.

16. The bearing of claim 15, wherein the fixed section is a cutoff surface.

17. The bearing of claim 15, wherein the fixed section is a screw flange which has a screw hole formed thereon.
